(19) United States
(12) Patent Application Publication
(10) Pub. No.: US 2002/0039905 A1
(43) Pub. Date: Apr. 4, 2002

(54) Process and device for calculating the position of a mobile station, corresponding computer program and memory medium

(76) Inventor: Jean-Gabriel Remy, Le Perreux (FR)

Correspondence Address: Robert M. Angus, Westman, Champlin & Kelly, International Centre, Suite 1600, 900 Second Avenue South, Minneapolis, MN, 55402-3319, US

(21) Appl. No.: 09/966,645

(22) Filed: Sep. 28, 2001

(30) Foreign Application Priority Data
Sep. 29, 2000 (FR) 00 12485

(51) Int. Cl. H04Q 7/20

(52) U.S. Cl. 455/456; 455/67.1; 342/357.02

(57) ABSTRACT

The invention relates to a process for calculating the position of a mobile station (MS) belonging to a cellular radiocommunication system, starting from an identifier of a current geographic cell in which the said mobile station is located. The process according to the invention includes the following steps: calculate a modelled geographic representation (5) of the current cell; calculate the barycenter (6) of the said modelled geographic representation of the current cell; calculate an uncertainty area (7), with a predetermined geometric shape, centerd on the said barycenter and the area of which is approximately equal to the area of the said modelled geographic representation of the current cell. The position of the mobile station is defined by the said barycenter, with an uncertainty equal to the said uncertainty area.

The domain of this invention is radiocommunication systems for communication with mobiles, particularly but not exclusively according to the UMTS (Universal Mobile Telecommunication System—2 GHz), GSM 900 (Global System for Mobile—900 MHz), DCS 1800 (Digital Cellular System—1800 MHz) and PCS 1900 (Personal Communication System—1900 MHz) standards.

More precisely, this invention relates to a process and a device for calculating the position of a mobile station belonging to a cellular radiocommunication system starting from an identifier of a current geographic cell in which this mobile station is located.

A “current geographic cell” means the cell in which the mobile station is located at the given moment. Remember that mobile stations move within a network of geographic cells. Each cell is associated with a base station that allows mobile stations within this cell to send and receive calls.

The terms “mobile station”, “radiotelephone” and “mobile” are used indifferently in the remainder of this description.

Conventionally, mobile positioning information is associated with signalling information related particularly to the identities of these mobiles, to enable the supply of geodependent services (in other words services related to positioning of mobiles). For example, geodependent services are intended to manage a fleet of vehicles or to provide information depending on the position (for example the local weather, downloading of geographic maps, indication of the closest restaurant, hotel, garage, etc.), possibly with routing of the call accordingly (by modifying the requested number).

Typically, the associated positioning and identification information for the different mobile stations is input to a positioning database that is referred to by geodependent service providers to satisfy requests from their customers. Typically, this positioning database is stored on a positioning server.

In the rest of this description, it is assumed that “raw” positioning information is available in the form of an identifier (for example the BSCI according to the GSM terminology) for the current cell in which the mobile is located. Typically, this is equivalent to considering that positioning is done by the network subsystem (NSS according to the GSM terminology) that determines the current cell starting from cell information contained in a signalling message (or a short message) sent by the mobile.

Consequently, we will not discuss other “radio frequency positioning” techniques such as GPS (Global Positioning System), OTD (Observed Time Distance), E-OTD (Enhanced Observed Time Difference), TDOA (Time Difference of Arrival), TA (Timing Advance), AOA (Angle of Arrival), etc. in this description.

The current technique for using the cell identifier as positioning information consists of using only the geographic position of the base station associated with the current cell. This is done by using a fixed correspondence table associating each cell identifier with the geographic position of a base station.

One advantage of the current technique is that the base station is in a building in a position that is perfectly defined in the land register. Another advantage of the current technique is that it can be used by an operator who is not thoroughly familiar with the radio prediction tool for geographic cells within the radiocommunication network (because he has purchased a standard commercially available tool).

However, this current technique does have some disadvantages.

Firstly, it is not sufficiently precise since the geographic position of the base station only rarely corresponds to the centre of the associated geographic cell. Most base stations are broken down into three sectors. Each base station is common to three geographic cells with equal angular apertures covering about 120° each. It can be understood that in this case, none of the three cells is centred on the geographic position of the common base station.

Another disadvantage of the current technique is that it takes no account of the uncertainty on the assumed position of the mobile. The position of the base station is always used. However, the mobile may be anywhere in the cell, and some cells may be larger than others.

Furthermore, the current technique mentioned above is based on a fixed correspondence table, consequently it cannot be used to easily monitor changes to the geographic cells network.

In particular, the purpose of the invention is to overcome these various disadvantages in the state of the art.

More precisely, one of the objectives of this invention is to supply a technique (process and device) for calculating the position of a mobile station starting from a current cell identifier, this technique being more precise than the current technique mentioned above.

Another purpose of the invention is to provide a calculation technique to take account of uncertainty on the assumed position of the mobile.

Another purpose of the invention is to provide such a calculation technique that can be easily adapted to any change in the geographic cells network.

These various objectives, and others that will be described later, are achieved according to the invention by means of a calculation process including the following steps:

calculate a modelled geographic representation of the current cell;

calculate the barycentre of the said modelled geographic representation of the current cell;

calculate an uncertainty area, with a predetermined geometric shape, centred on the said barycentre and the area of which is approximately equal to the area of the said modelled geographic representation of the current cell.

The position of the mobile station is defined by the said barycentre, with an uncertainty equal to the said uncertainty area.

Therefore the general principle of the invention consists of calculating a barycentre representation (barycentre and geometric shape centred on this barycentre) of the current cell, starting from a modelled geographic representation of this current cell.

This calculation is independent of the position of the base station, and is much more precise than the calculation used in the above mentioned current technique. Note also that the uncertainty area around the position of the mobile is smaller when the current cell is smaller.

Preferably, the said calculation of a modelled geographic representation of the current cell consists of using a radio prediction tool to calculate a set of points in which the radio frequency field in the current cell is stronger than that in other cells.

In this way, the modelled geographic representation of the current cell is close to reality, and the calculation of the position of the mobile and the associated uncertainty is precise. The operator of the radiocommunication system usually already has such a radio prediction tool that he can use to optimise management and maintenance of his network. Therefore advantageously, this current radio prediction tool is used to calculate the modelled geographic representation of the current cell.

Preferably, the said geometric shape belongs to the group comprising disks and polygons (preferably hexagons, squares and equilateral triangles). These geometric shapes help to simplify the calculations. However, it is clear that other geometric shapes could be envisaged without going outside the scope of this invention.

In one particular embodiment, the said geometric shape is a polygon and the said polygon is oriented along the largest direction of the current cell. This optimises the calculation of the uncertainty area.

In one particular embodiment of the invention, the position of the mobile station is calculated dynamically. In this way, this invention makes it easy to adapt to any change in the geographic cells network.

Advantageously, the said process comprises a prior step to extract the identifier of the current cell from at least one signal message circulating on the radiocommunication system network.

In one particular embodiment, the said extraction is triggered if at least one of the following conditions is satisfied when the mobile station makes a call:

the number of the mobile station belongs to a predetermined list of calling numbers;

the number called by the mobile station belongs to a predetermined list of called numbers;

the current cell belongs to a predetermined list of cells.

According to one advantageous application, the position of the mobile station and the associated uncertainty are input into a positioning database to enable the supply of at least one geodependent service.

This positioning database can be queried by a single geodependent service provider, or it may be shared by several geodependent service providers. For example, it may be managed by the radiocommunication system operator.

For each mobile with a defined position, the positioning database stores:

a mobile identifier (for example IMSI or TMSI);

the position of the mobile with the uncertainty on this position, resulting from the barycentre calculation according to the invention;

any other signalling information, for example related to the requested communication type, the requested number, etc.

The invention also relates to a device for calculating the position of a mobile station belonging to a cellular radiocommunication system starting from the identifier of a current geographic cell in which the said mobile station is located. The device according to the invention comprises:

means of calculating a modelled geographic representation of the current cell;

means of calculating the barycentre of the said modelled geographic representation of the current cell;

means of calculating an uncertainty area, with a predetermined geometric shape centred on the said barycentre and the area of which is approximately equal to the area of the said modelled geographic representation of the current cell;

the position of the mobile station being defined by the said barycentre with an uncertainty equal to the said uncertainty area.

Preferably, the said device is integrated into a radio frequency planning tool for the geographic cells in the said cellular radiocommunication system.

In this way, the costs are limited by using equipment already available to the operator.

The invention also relates to a computer program comprising instruction sequences adapted to the use of a process for calculating the position of a mobile station according to the invention.

The invention also relates to a memory medium that can be read by a computer and that contains a program that, when it is executed by the computer, makes the computer capable of using the process to calculate the position of the mobile station according to the invention.

Other characteristics and advantages of the invention will become clear after reading the following description of a preferred embodiment of the invention, given as an example for information and which is in no way limitative, and the attached drawings in which:

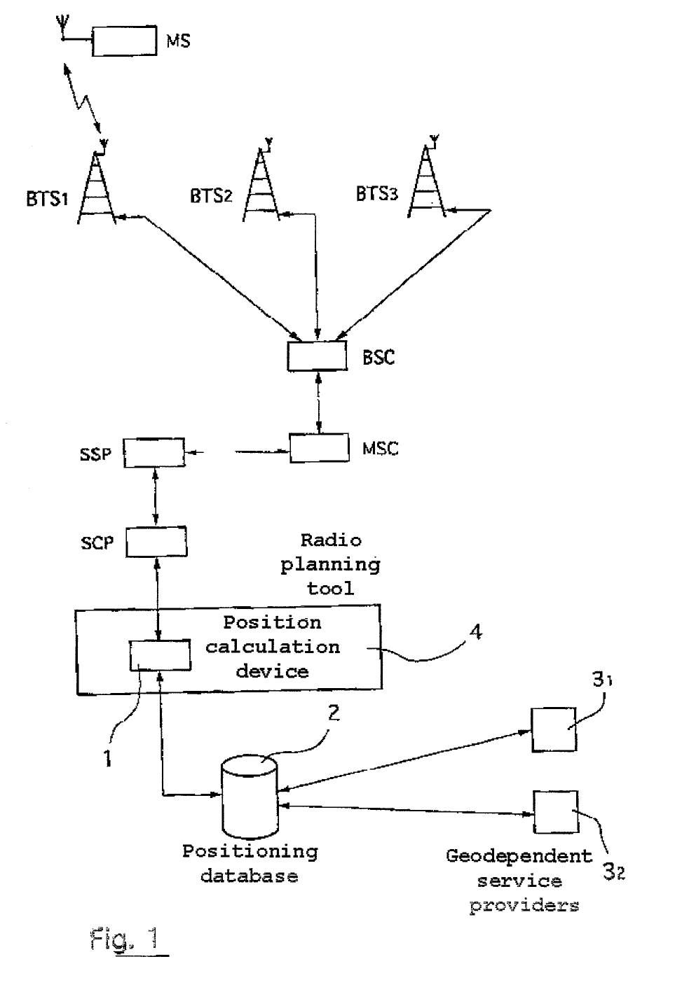

FIG. 1 contains a block diagram illustrating a radiocommunication system in which a particular embodiment of the process according to the invention is used to calculate the position of a mobile;

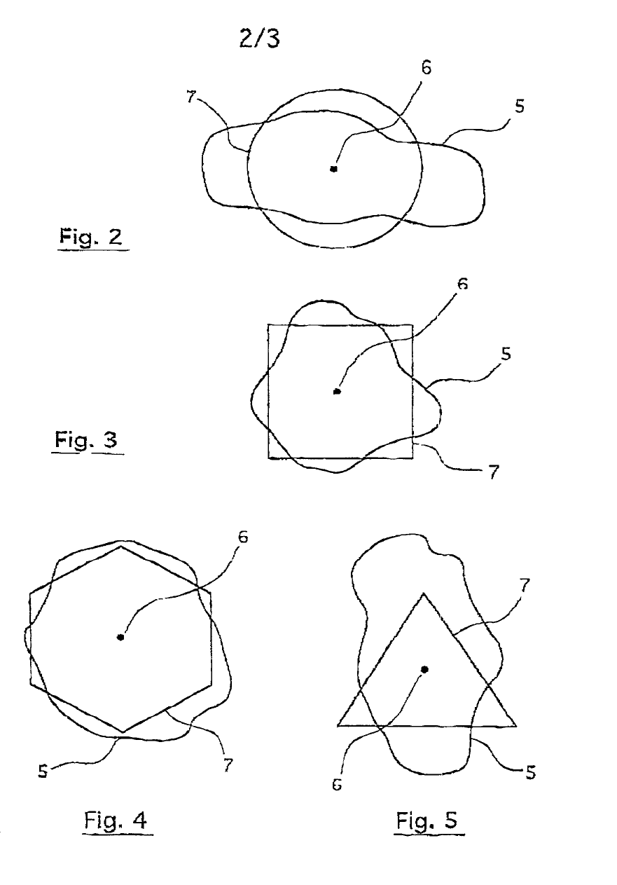

FIGS. 2 to 5 each illustrate a particular embodiment of the geometric shape (disk, square, hexagon and triangle respectively) of the uncertainty area calculated by the process according to the invention;

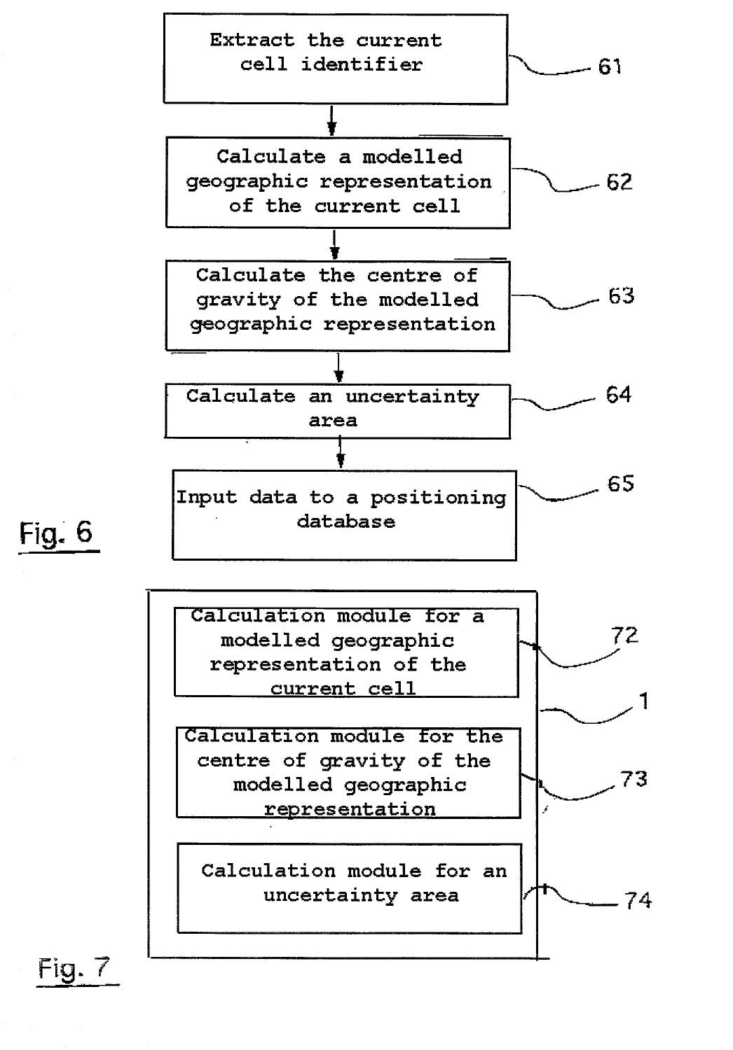

FIG. 6 shows a simplified flow chart of a particular embodiment of the process according to the invention for calculating the position of a mobile; and

FIG. 7 shows a block diagram of a particular embodiment of the process for calculating the position according to this invention, shown in FIG. 1.

The invention therefore relates to a process and device for calculating the position of a mobile starting from the identifier of a geographic cell in which this mobile is located (called the “current cell” in the remainder of the description).

A cellular radiocommunication system according to the GSM standard is considered in the remainder of the description. However, it is obvious that the invention is not limited to this type of system.

Remember that conventionally, a cellular GSM network comprises at least one mobile service switch (MSC according to the GSM terminology) enabling interconnection of the cellular network with a fixed telephone network (for example the Public Switched Telephone Network). At least one base station controller (BSC, according to the GSM terminology) is connected to each MSC. At least one base station (BTS according to the GSM terminology) is connected to each BSC. Each BTS provides coverage for a distinct geographic area called a “cell” in which mobile stations (MS according to the GSM terminology) can move around. Part of such a GSM network is illustrated in FIG. 1, which diagrammatically shows an MSC, a BSC, three base stations BTS₁ to BTS₃ and a mobile MS. At the moment considered, it is assumed that the current cell of the mobile MS is the cell associated with the base station reference BTS₁.

In a particular embodiment illustrated by the simplified flow chart in FIG. 6, the process according to the invention comprises the following steps:

extract (61) the current cell identifier contained in a signalling message;

calculate (62) the modelled geographic representation of the current cell;

calculate (63) the barycentre of the modelled geographic representation, this barycentre being the calculated position of the mobile;

calculate (64) an uncertainty area, defining the uncertainty on the calculated position of the mobile;

input data (65) to a positioning database, with the position of the mobile station and the associated uncertainty.

We will now describe each of these steps 61 to 65 in detail.

Step 61: Extract the Current Cell Identifier Contained in a Signalling Message.

When the mobile starts a call in telephony mode (circuit outgoing call) or in packet mode (GPRS, UMTS or SMS outgoing call), the signal circulating on the network subsystem (NSS) carries the calling party's number, the called party's number and the identifier of the cell from which the call originated (current cell). This information is present particularly in the initial address message (MIF/IAM in CCITT No.7 signalling) that passes through the MSC.

As shown in FIG. 1 as an example, the following capture and extraction mechanism may be used according to the intelligent network (IN) concept, in order to obtain this information:

an SSP (Service Switching Point, also called Trigger point) connected to (or built into) the MSC, scans the MIF for each new call, and when it detects that a trigger condition is satisfied, it sends this MIF to the Service Check Point (SCP);

the SCP extracts the current cell identifier (and possibly the called number and the calling mobile identifier) from the MIF supplied to it by the SSP, and then sends extracted information to a position calculation device 1.

The capture and extraction mechanism described above is applicable essentially to a call in telephony mode (circuit outgoing call). However, it may easily be transposed to the processing of a call in packet mode (GPRS, UMTS or SMS outgoing call) without going outside the scope of this invention.

For example, the network operator selects the triggering condition. Several conditions may be combined. For example, the following conditions may be mentioned:

the calling number belongs to a predetermined list of calling numbers.

For example, some subscribers may have subscribed to a systematic and possibly implicit positioning service;

the called number belongs to a predetermined list of called numbers. For example, calls to particular servers may be detected. For example, they may be servers of geodependent service providers 3₁, 3₂;

the current cell belongs to a predetermined list of cells.

Step 62: Calculate the Modelled Geographic Representation of the Current Cell.

The modelled geographic representation of the current cell is calculated using a radio prediction tool to calculate a set of geographic points in which the current cell has a radio frequency field stronger than in other cells (“best server” concept). In other words, the mobile locks on to this cell (in other words it communicates through the base station associated with this cell) only at these geographic points. Elsewhere, the mobile switches to other cells by handover or reselection.

For example, the layout of the area of a geographic cell may be calculated dynamically by an RF (radio frequency) planning tool that the operator already has for management and maintenance of his network. This tool is also sometimes called a “cellular network radio prediction tool”.

The radio prediction tool is software that starts from base station data and calculates the electrical field produced at all geographic points. The base station is characterized in this respect by the antenna diagram (X, Y, Z) describing the gain in dB applicable to each direction starting from the base station, and by the power supplying the antenna at the RF frequency considered.

The calculation algorithms used are broken down into two families:

“heuristic” methods: the electrical field is obtained by a logarithmic addition (in dB) of the various attenuations of the path considering the relief and the nature of the ground along the path. The most common is the Okumura-Hata formula;

“start beam” or similar methods: the algorithm attempts to reconstruct radio electric wave paths to deduce the attenuation along the path (for example Walfish-Ikegomi).

These calculations give approximate values (errors of the order of 6 dB tolerated).

The “pixel” (basic element) used in the calculation is a square, for example 50 m×50 m. The calculation becomes more precise and more complicated as the square becomes smaller.

When the value of the field received from the various base stations is available at a given point, the “best server” calculation consists of comparing these data and identifying the cell that produces the highest electrical field.

The geometric location of the points at which a cell produces a field stronger than all others is the area in which this cell is the “best server”. This area varies:

with the topology of the cellular network (addition of new cells);

with characteristic parameters of the cell at the base station (antenna input power, antenna type, “tilt” value, antenna orientation, etc.).

Step 63—Calculate the Barycentre of the Modelled Geographic Representation.

The barycentre of the modelled geographic representation is calculated with the set of geographic points that make it up. This calculation is based on a conventional mathematical algorithm which will not be described in detail further.

Step 64—Calculate the Uncertainty Area

The uncertainty area is calculated to have a predetermined geometric shape, to be centred on the barycentre (calculated in step reference 53) and such that the area is approximately equal to the area of the modelled geographic representation of the current cell (calculated in step reference 62).

Several geometric shapes could be envisaged for the uncertainty area, namely particularly but not exclusively a disk (FIG. 2), a square (FIG. 3), a hexagon (FIG. 4) or a triangle (preferably equilateral) (FIG. 5). FIGS. 2 to 5 show the modelled geographic representation of the current cell reference 5, the barycentre of this geographic representation reference 6, and the uncertainty area reference 7.

In general, if the geometric shape is a polygon, the polygon is oriented along the larger direction of the current cell. For example, the orientation process may consist of scanning the area of the modelled geographic representation (“best server” area) using a straight line passing through the barycentre and being equal to all possible orientations in sequence (for example, North to East, then South, West, and then North again). The segments intercepted between the barycentre and the most remote point are then measured. Finally, the “vertex” (or one of the “vertices”) of the polygon is oriented in the direction in which the largest intercepted segment was measured. In other words, the largest intercepted segment is aligned with the diagonal of the square, or with the height of the equilateral triangle, or with the “diameter” of the hexagon.

This invention is particularly advantageous when the steps in which the barycentre and the uncertainty area references 62 and 63 are calculated dynamically.

In the example described above, steps reference 62 and 64 are used by a position calculation device 1 that comprises appropriate calculation modules (reference 72 to 74 respectively shown in FIG. 7). For example, these calculation modules may consist of a computer program executed on a computer. Conventionally, this computer program may be stored on a memory medium (diskette, hard disk, CD-ROM, DVD, etc.) that can be read by the computer.

For example, this device 1 is integrated into a tool 4 (FIG. 1) for the management and maintenance of the cellular network that is already in the possession of the radiocommunication system operator, namely the above mentioned geographic cell radio frequency planning tool.

Step 65—Input Data to a Positioning Database

The position of the mobile and the uncertainty on this position resulting from the barycentre calculation according to the invention, are stored in a positioning database 2 (also called the positioning server).

For each mobile, the positioning database associates other information with this positioning and uncertainty information, for example such as:

time dating information;

a mobile identifier, for example such as the IMSI (International Mobile Subscriber Identity), or TMSI (Temporary Mobile Subscriber Identity);

the nature of the measurement, namely “network capture” in this case. In the case in which the positioning database also stores positioning information obtained according to other techniques (GPS, direction finding, EOTD, etc.);

the signalling message type (for example MIF) from which the raw positioning information was extracted (in other words the current cell identifier in this case);

the called number;

etc.

For example, this positioning database may be updated periodically or according to any other strategy. Optionally, it keeps information about several successive measurements of the same mobile for a relatively long period (at least an hour). For example, according to a particular application associated with these successive measurements, it would be possible to determine the direction of displacement of the mobile, or to eliminate an indetermination between two similar routes.

For example, subject to appropriate controls, it may be viewed by geodependent service providers 3₁, 3₂, who would like to obtain information that they can use to answer requests made by their customers.

It is obvious that other embodiments of the invention could be envisaged without going outside the scope of this invention.

1. Process for calculating the position of a mobile station (MS) belonging to a cellular radiocommunication system, starting from an identifier of a current geographic cell in which the said mobile station is located,
characterized in that it includes the following steps:
calculate a modelled geographic representation (5) of the current cell;
calculate the barycentre (6) of the said modelled geographic representation of the current cell;
calculate an uncertainty area (7), with a predetermined geometric shape, centred on the said barycentre and the area of which is approximately equal to the area of the said modelled geographic representation of the current cell;
and in that the position of the mobile station is defined by the said barycentre, with an uncertainty equal to the said uncertainty area.

2. Process according to claim 1, characterised in that the said calculation of a modelled geographic representation (5) of the current cell consists of using a radio prediction tool to calculate a set of points in which the radio frequency field in the current cell is stronger than that in other cells.

3. Process according to either of claims 1 or 2, characterised in that the said geometric shape belongs to the group comprising;
disks;
polygons, preferably hexagons, squares and equilateral triangles.

4. Process according to either of claims 1 or 2, characterised in that the said geometric shape is a polygon and in that the said polygon is oriented along the largest direction of the current cell.

5. Process according to any one of claims 1 to 4, characterised in that the position of the mobile station is calculated dynamically.

6. Process according to any one of claims 1 to 5, characterised in that it comprises a prior step to extract the identifier of the current cell from at least one signal message circulating on the radiocommunication system network.

7. Process according to claim 6, characterised in that the said extraction is triggered if at least one of the following conditions is satisfied when the mobile station makes a call:
the number of the mobile station belongs to a predetermined list of calling numbers;
the number called by the mobile station belongs to a predetermined list of called numbers;
the current cell belongs to a predetermined list of cells.

8. Process according to any one of claims 1 to 7, characterised in that the position of the mobile station and the associated uncertainty are input into a positioning database (2) so that at least one geodependent service can be provided.

9. Device (1) for calculating the position of a mobile station belonging to a cellular radiocommunication system starting from the identifier of a current geographic cell in which the said mobile station is located,
characterized in that it comprises:
means of calculating a modelled geographic representation (5) of the current cell;
means of calculating the barycentre (6) of the said modelled geographic representation of the current cell;
means of calculating an uncertainty area (7), with a predetermined geometric shape centred on the said barycentre and the area of which is approximately equal to the area of the said modelled geographic representation of the current cell;
the position of the mobile station being defined by the said barycentre with an uncertainty equal to the said uncertainty area.

10. Process according to claim 9, characterised in that it is integrated into a radio frequency planning tool (4) for the geographic cells in the said cellular radiocommunication system.

11. Computer program comprising portions/means/program code instructions for execution of the steps in the process according to any one of claims 1 to 8 when the said program is executed on a computer.

12. Computer program intended for calculating the position of a mobile station (MS) belonging to a cellular radiocommunication system starting from an identifier of a current geographic cell in which the said mobile station is located, the said computer program comprising portions/means/program code instructions recorded on a medium that can be used in a computer, comprising:
programming means that can be read by a computer to perform the calculation step for a modelled geographic representation (5) of the current cell;
programming means that can be read by a computer to perform the calculation step to determine the barycentre (6) of this said modelled geographic representation of the current cell;
programming means that can be read by a computer to perform the calculation step to determine an uncertainty area (7) with a predetermined geometric shape centred on the said barycentre and the area of which is approximately equal to the area of the said modelled geographic representation of the current cell; the position of the mobile station being defined by the barycentre, with an uncertainty equal to the uncertainty area.
